(19) United States
(12) Patent Application Publication
(10) Pub. No.: US 2006/0134519 A1
(43) Pub. Date: Jun. 22, 2006

(54) Alkaline accumulator

(76) Inventors: Detlef Ohms, Gottingen (DE); Gunter Schadlich, Neukirchen (DE)

Correspondence Address: HARNESS, DICKEY & PIERCE, P.L.C., P.O. BOX 828, BLOOMFIELD HILLS, MI, 48303, US

(21) Appl. No.: 11/297,799

(22) Filed: Dec. 8, 2005

(30) Foreign Application Priority Data
Dec. 10, 2004 (EP) 04029304.5

(51) Int. Cl. H01M 4/32

(52) U.S. Cl. 429/223

(57) ABSTRACT

The invention relates to a nickel-cadmium battery having pocket-type plate negatives. In order to vary the properties of nickel-cadmium batteries having pocket-type plate negatives such that the unfavourable long-term behaviour is avoided and better endurance data can be achieved, the invention proposes to use fibre pattern electrodes as positive electrodes.

The present invention relates to a nickel-cadmium battery having pocket-type plate negatives for the electrochemical accumulation of energy.

Batteries and accumulators have become an essential part of daily life, without them neither electrical starters in motor vehicles nor mobile phones function. Principally, these energy accumulators are composed of an anode, an electrolyte and a cathode. The metals, of which the electrodes are usually made, ionize on contact with the electrolyte. Depending on the used materials, a different potential is generated at the two electrodes and thus a potential difference results by means of which energy can be drawn from the accumulator or the battery.

A big part of alkaline batteries and accumulators is based upon the use of pocket-type plate electrodes on both the positive and the negative cell side. Besides, energy accumulators are known, in which self-baking electrodes are used on both sides, or self-baking electrodes on the one hand and plastic-bound electrodes on the other hand or electrodes of fibre pattern technique on both sides. Nickel-cadmium cells having pocket-type plate cells are used for a number of applications in the stationary and mobile energy accumulation, but they have the drawback that the endurance of the cells at the positive electrode deteriorates due to chemical secondary reactions. This leads to a quicker aging and thus to a shorter service life. Besides, these electrodes require measures for the improvement or stabilisation of the electrical conductivity, which also have a negative effect on the long-term behaviour.

It is thus the object of the invention to modify the properties of nickel-cadmium batteries having pocket-type plate negatives, such that the unfavourable long-term behaviour is avoided and better endurance data are achieved.

This aim is achieved according to the invention in that a positive electrode of fibre pattern technology is used instead of the positive pocket-type plate electrode.

Pocket-type plate electrodes are structured in such a way that usually perforated plates or sheet metals made of nickel or nickel-plated carrier material, such as for example steel sheet, are arranged in form of pockets and an electrochemically active material mass is introduced into these pockets. For electrical and spatial separation, a separator or spacer is used. The drawback of such electrodes is that they present a reduced efficiency with respect to storable energy and that additions for improving the conductivity are unavoidably required. These additions are electrochemically instable.

Electrodes of fibre pattern technology present a porous shell made of bonded fibre fabric or needled felt, which is provided with a thin metal layer and filled with an electrochemically active material mass. Due to the low weight of the shell, the efficiency with respect to storable energy per weight is improved and an improvement of the endurance by an improved contacting of the active material is obtained. Besides, the porous structure leads to a larger electrode surface and thus a higher endurance. However, it is a drawback that the production costs are significantly higher in comparison to a pocket-type plate electrode.

According to the present invention, an alkaline nickel-cadmium cell having pocket-type plate negatives is characterized in that the positive electrodes are fibre pattern electrodes. Herein, the particular advantage is the economic production of such a hybrid cell while simultaneously avoiding the above mentioned drawbacks.

Furthermore it is proposed that the capacity of the electrodes is chosen such that during the discharge of the cell, the positive fibre pattern electrodes limit the discharge process. Therefore, the surface capacity of the positive electrode is chosen accordingly. It is thus achieved that a certain minimum capacity of the negative pocket-type plate electrode is always reached and thereby the long-term behaviour of the energy accumulator is significantly improved.

According to a further proposal, the cell is characterized in that the number of the positive electrodes is smaller than or equal to the one of the negative electrodes and they are alternately arranged, such that the outer electrodes are negative pocket-type plate electrodes. If the electrodes are placed in sequential layers, the number of the positive electrodes will be smaller than the one of the negative electrodes, such that the outer ones are negative electrodes.

According to another characteristic of the invention, the outer negative electrodes are less densely filled with active material mass than the inner negative electrodes. In the common serial connection of individual cells, the capacity of the entire accumulator or the entire battery is limited by the capacity of the smallest individual cell.

It has been found that the fibre pattern electrodes ideally have surface capacities comprised between preferably 50 mAh/cm² and 250 mAh/cm² (with respect to the electrode geometry). The advantages of a variable surface capacity of the positive electrode are that an adaptation to the narrow methods which result from the production of the negative pocket-type plates can be realized. This is for example possible by varying the starting material, which is used for the production of the fibre pattern electrodes, and by adapting the active material masses and the material. A variation of thicknesses is carried out. Herein, the capacity range comprised between 50 mAh/cm² and 250 mAh/cm² is a suitable compromise between the desired total capacity of the accumulator or battery and the production effort.

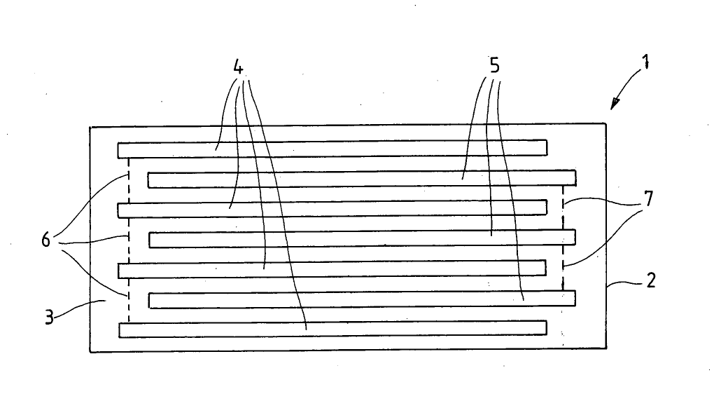

In the following, the invention will be explained in more detail by means of an exemplary embodiment. Herein, the only FIG. 1 shows the schematic structure of an alkaline accumulator according to the invention.

As it can be seen in the schematic representation of FIG. 1, the accumulator according to the invention 1 comprises a housing 2. This housing 2 serves for receiving negative electrodes 4 and positive electrodes 5, wherein an electrolyte 3 is placed between the individual electrodes, which electrolyte serves for the generation of an electrochemical potential, on the one hand, and for the transport of ions, on the other hand. According to the invention, the negative electrodes 4 are pocket-type plate electrodes and the positive electrodes 5 are fibre pattern electrodes.

As it is visible in FIG. 1, the negative electrodes 4 and the positive electrodes 5 are alternately arranged in such a way that they overlap each other, wherein the two outer electrodes are negative electrodes 4, such that accumulator 1 has four negative electrodes. 4 and three positive electrodes 5 in total. Other embodiments are of course imaginable, since according to the invention it is only important that the positive electrodes 5 are fibre pattern electrodes and the negative electrodes 4 are pocket-type plate electrodes.

In the non-overlapping region, electrodes 4 or 5 form so called suspension lugs, which serve for simple electrical contacting. This is schematically represented in FIG. 1 by dashed lines, wherein the electrical connection of the negative electrodes 4 is indicated by reference numeral 6 and the electrical connection of the positive electrodes is indicated by reference numeral 7.

Accumulator 1 according to the invention is characterized in that it has a better endurance due the alternating arrangement of pocket-type plate electrodes and fibre pattern electrodes and shows less aging effects than batteries or accumulators as they are known from the state of the art. Furthermore, accumulator 1 according to the invention can be manufactured and used in an economic way.

It is to be understood that the exemplary embodiment described by means of the schematic FIG. 1 is only meant for explanation. Alternative embodiments within the scope of the invention are imaginable. Thus, variations are possible with respect to the size and number of the used electrolytes, to the arrangement of the same ones in the housing of the accumulator as well as with respect to an electric contacting of the individual electrodes. For the invention it is only essential that the negative electrodes are pocket-type plate electrodes and the positive electrodes are fibre pattern electrodes.

### LIST OF REFERENCE NUMERALS

1 accumulator
2 housing
3 electrolyte
4 negative electrode (pocket-type plate electrode)
5 positive electrode (fibre pattern electrode)
6 electrical connection
7 electrical connection

1. An alkaline nickel-cadmium cell comprising pocket-type plate negatives, and
fibre pattern electrodes serving as positive electrodes.

2. An alkaline cell according to claim 1, wherein the capacity of the electrodes is chosen, such that, during the discharge of the cell, the positive fibre pattern electrodes limit the discharge process.

3. An alkaline cell according to claim 1, wherein the number of the positive electrodes is smaller than or equal to the one of the negative electrodes and they are alternately arranged, such that the outer electrodes are negative pocket-type plate electrodes.

4. An alkaline cell according to claim 3, wherein the outer negative electrodes are less densely filled with active material mass than the inner negative electrodes.

5. An alkaline cell according to claim 3, wherein the fibre pattern electrodes have surface capacities comprised between preferably 50 mAh/cm² and 250 mAh/cm² (with respect to the electrode geometry).
